(19) United States
(12) Patent Application Publication
(10) Pub. No.: US 2022/0252540 A1
(43) Pub. Date: Aug. 11, 2022

(54) SENSOR ELEMENT

(71) Applicant: NGK Insulators, Ltd., Nagoya-Shi (JP)

(72) Inventors: Mika TAKEUCHI, Susono-Shi (JP); Megumi FUJISAKI, Kuwana-Shi (JP); Kosuke UJIHARA, Obu-Shi (JP); Takahiro TOMITA, Chita-Shi (JP)

(73) Assignee: NGK Insulators, Ltd., Nagoya-Shi (JP)

(21) Appl. No.: 17/661,294

(22) Filed: Apr. 29, 2022

Related U.S. Application Data
(63) Continuation of application No. PCT/JP2020/041219, filed on Nov. 4, 2020.

(30) Foreign Application Priority Data
Nov. 5, 2019 (JP) 2019-200859

(51) Int. Cl. G01N 27/409; G01M 15/10; G01N 27/416

(52) U.S. Cl. CPC G01N 27/409; G01N 27/416; G01M 15/102

(57) ABSTRACT

A sensor element comprises an element body and a porous protective layer covering a surface of the element body. In this sensor element, the porous protective layer comprises a first layer exposed on a surface of the sensor element and a second layer disposed between the element body and the first layer. The first layer contains ceramic particles and anisotropic ceramics having an aspect ratio of 5 or more and 100 or less, and a part of the first layer is in contact with the element body. Further, a porosity of the second layer is 95 vol % or more.

### TECHNICAL FIELD

The present application claims priority based on Japanese patent application No. 2019-200859 filed on Nov. 5, 2019, the entire contents of which is incorporated herein by reference.

### BACKGROUND ART

JP 2016-188853 A (hereinbelow termed Patent Document 1) describes a sensor element that covers an element body by an inorganic porous protective layer. Within a range covered by the porous protective layer, the sensor element of Patent Document 1 has a region in which the porous protective layer is in contact with the element body and a region in which a clearance (space) is defined between the porous protective layer and the element body. That is, an air layer is arranged between the porous protective layer and the element body so as to thermally insulate the porous protective layer from the element body. As a result, when moisture adheres to the porous protective layer while the sensor element is operating, the sensor element in high temperature is suppressed from being rapidly cooled, and deterioration of the sensor element can thereby be suppressed.

### SUMMARY OF INVENTION

### Technical Problem

Patent Document 1 also describes a configuration in which a plurality of pillars is arranged between the porous protective layer and the element body within the region in which the space is defined between the porous protective layer and the element body. By arranging the pillars, the porous protective layer is supported at multiple points, and strength of the porous protective layer can be improved. However, when such pillars are arranged between the porous protective layer and the element body, a contact area between the porous protective layer and the element body increases by these pillars, and thermal insulation between the porous protective layer and the element body decreases. Thus, in the technique of Patent Document 1, the shape of the sensor element and the number of the pillars to be arranged between the porous protective layer and the element body need to be tailored in accordance with purpose and application. In view of the above, in the field of sensor elements, realization of a structure with higher versatility is in demand. The description herein aims to provide a novel sensor element with high versatility.

### Solution to Technical Problem

A sensor element disclosed herein comprises an element body and a porous protective layer covering a surface of the element body. In this sensor element, the porous protective layer may comprise a first layer exposed on a surface of the sensor element and a second layer disposed between the element body and the first layer. The first layer may contain ceramic particles and anisotropic ceramics having an aspect ratio of 5 or more and 100 or less, and a part of the first layer may be in contact with the element body. Further, a porosity of the second layer may be 95 vol % or more.

### BRIEF DESCRIPTION OF DRAWINGS

FIG. 1 shows an outer appearance of a sensor element of a first embodiment (perspective view).

FIG. 2 shows a cross-sectional view along a line II-II in FIG. 1.

FIG. 3 shows a cross-sectional view along a line III-III in FIG. 1.

FIG. 4 shows a cross-sectional view along a line IV-IV in FIG. 1.

FIG. 5 shows a schematic view of an outer layer of the sensor element of the first embodiment.

FIG. 6 shows a cross-sectional view of a sensor element of a second embodiment.

FIG. 7 shows a cross-sectional view of a sensor element of a third embodiment.

FIG. 8 shows a cross-sectional view of a sensor element of a fourth embodiment.

FIG. 9 shows a shows a cross-sectional view of a sensor element (gas sensor) used in Examples.

FIG. 10 shows results of the Examples.

### DESCRIPTION OF EMBODIMENTS

A sensor element disclosed herein may for example be used as a gas sensor for detecting a concentration of a specific component in air. As examples of such gas sensor, a NOx sensor configured to detect a NOx concentration in exhaust gas of a vehicle having an engine, and an air-fuel ratio sensor (oxygen sensor) configured to detect an oxygen concentration may be exemplified.

The sensor element may comprise an element body (member in which a sensor structure is constructed) and an inorganic porous protective layer that covers a surface of the element body. The porous protective layer may cover a part of the element body, especially a portion thereof where the sensor structure is constructed. The sensor element may be in a stick shape, and the porous protective layer may cover a range thereof from a longitudinally intermediate portion to one end in the longitudinal direction of the sensor element. For example, when the sensor element is a gas sensor, the porous protective layer may cover a portion where a detection unit configured to detect detection-target gas is arranged. As an example, the porous protective layer may cover less than half of a longitudinal length of a sensor body, such as a range of ⅕ to ⅓ of the longitudinal length from an end thereof in the longitudinal direction.

The porous protective layer may comprise a first layer exposed on a surface of the sensor element and a second layer arranged between the element body and the first layer. The first layer may contain ceramic particles and anisotropic ceramics having an aspect ratio of 5 or more and 100 or less. The second layer may have a porosity of 95 vol % or more. Since the first layer contains the ceramic particles and the anisotropic ceramics, strength of the first layer itself can be improved as compared to a case of fabricating the first layer using only the ceramic particles. Due to this, even if there is a low-density layer (second layer) interposed between the first layer and the element body, strength of the porous protective layer can still be maintained. “The porosity of the second layer being 95 vol % or more” includes, in addition to a configuration in which the second layer is constituted of a material of which volume ratio is less than 5% (porosity of 95% or more), a configuration in which the second layer is a space (that is, with 100% porosity).

Further, the second layer may be in contact with the surface of the element body, or may be noncontact with the surface of the element body. For example, a third layer may cover the surface of the element body (portion where the first layer is not in contact), and the second layer may be arranged between the first layer and the third layer. Similar to the first layer, the third layer may contain the ceramic particles and the anisotropic ceramics having the aspect ratio of 5 or more and 100 or less. The third layer may be constituted of same material as that of the first layer. That is, in the sensor element disclosed herein, a configuration of the second layer and a position where the low-density layer is to be arranged are arbitrary so long as the second layer (low-density layer) is present on an inner side (element body side) of the first layer.

A part of the first layer may be in contact with the element body. That is, a portion where the second layer does not exist and the first layer is in direct contact with the element body may be present between the first layer and the element body. For example, within a range in which the porous protective layer covers the element body, an area ratio (R1) of an area (S2) of the portion where the first layer is in direct contact with the element body with respect to a surface area (S1) of the element body may be 10% or more and 80% or less. In other words, within the range in which the porous protective layer covers the element body, an equation (1) as follows may be satisfied, where the surface area of the element body (including the portion where the first layer is in contact with the element body) is S1 and the contact area between the element body and the first layer is S2. Here, the surface area of the element body means an entire outer surface of the element body (including front and rear surfaces, side surfaces, and end surfaces).

10≤(S2/S1)×100≤80 (1)

When the area ratio R1 ((S2/S1)×100) is 10% or more, the strength of the porous protective layer is sufficiently ensured. Further, when the area ratio R1 is 80% or less, thermal insulation between the porous protective layer and the element body can sufficiently be ensured. The area ratio R1 may be 15% or more, 18% or more, 25% or more, 30% or more, or 45% or more. Further, the area ratio R1 may be 75% or less, 72% or less, 55% or less, 45% or less, 30% or less, or 25% or less.

In the case where the porous protective layer covers the stick-shaped sensor element in the range from the longitudinally intermediate portion to the one end in the longitudinal direction, the first layer may at least be in contact with the element body at an end of the sensor element on a longitudinally intermediate portion side (hereinbelow termed a first end). Further, in addition to the first end, the first layer may be in contact with the element body at an end of the sensor element on a longitudinal end side (hereinbelow termed a second end) and/or may be locally in contact with the element body between the first and second ends. That is, the first layer may be in contact at multiple points with the element body.

A thickness of the first layer may be 50 μm or more and 950 μm or less. When the thickness of the first layer is 50 μm or more, the strength of the porous protective layer can sufficiently be ensured. Further, when the thickness of the first layer is 950 μm or less, gas outside the sensor element can easily pass through the porous protective layer and move to the element body. The thickness of the first layer may be 100 μm or more, 200 μm or more, 300 μm or more, or 500 μm or more. Further, the thickness of the first layer may be 800 μm or less, 600 μm or less, 500 μm or less, or 400 μm or less.

A thickness of the second layer may be 50 μm or more and 950 μm or less. When the thickness of the second layer is 50 μm or more, the first layer and the element body can sufficiently be thermally insulated from each other. Further, when the thickness of the second layer is 950 μm or less, the strength of the porous protective layer can sufficiently be ensured. The thickness of the second layer may be 100 μm or more, 200 μm or more, 300 μm or more, or 500 μm or more. Further, the thickness of the second layer may be 800 μm or less, 600 μm or less, 500 μm or less, or 400 μm or less. In the sensor element disclosed herein, a thickness of the porous protective layer (distance from the surface of the element body to a surface where the first layer is externally exposed) may be 100 μm or more and 1000 μm or less. The aforementioned functions (strength and thermal insulation) can sufficiently be exhibited.

A porosity of the first layer may be 5 vol % or more and 50 vol % or less. When the porosity of the first layer is 5 vol % or more, the gas outside the sensor element can easily pass through the porous protective layer and move to the element body. Further, when the porosity of the first layer is 50 vol % or less, the strength of the porous protective layer can sufficiently be ensured. The porosity of the first layer may be 10 vol % or more, 15 vol % or more, or 20 vol % or more. Further, the porosity of the first layer may be 40 vol % or less, 32 vol % or less, or 20 vol % or less.

A volume fraction of the anisotropic ceramics in the first layer may be 20 vol % or more and 80 vol % or less with respect to a total volume of the ceramic particles and the anisotropic ceramics. When the volume fraction of the anisotropic ceramics in the first layer is 20 vol % or more, the strength of the first layer can sufficiently be ensured, and further, excessive sintering of the ceramic particles in a manufacturing process (firing step) of the porous protective layer can be suppressed from occurring. Further, when the volume fraction of the anisotropic ceramics is 80 vol % or less, heat transfer paths within the first layer can be blocked and a thermal insulation performance of the first layer thereby improves, as a result of which a thermal insulation performance of the porous protective layer is improved. The volume fraction of the anisotropic ceramics in the first layer may be 30 vol % or more, 40 vol % or more, 50 vol % or more, or 60 vol % or more. Further, the volume fraction of the anisotropic ceramics in the first layer may be 70 vol % or less, 60 vol % or less, or 50 vol % or less. Although details will be described later, the anisotropic ceramics may contain plate-shaped ceramic particles of which maximum diameter is relatively short (5 μm or more and 50 μm or less) and/or ceramic fibers of which maximum diameter is relatively long (50 μm or more and 200 μm or less).

As aforementioned, the anisotropic ceramics may contain the plate-shaped ceramic particles of which maximum diameter is relatively short and the ceramic fibers of which maximum diameter is relatively long. That is, a maximum diameter of the anisotropic ceramics may be 5 μm or more and 200 μm or less. Further, a minimum diameter of the anisotropic ceramics may be 0.01 μm or more and 20 μm or less. The “maximum diameter” means a length that becomes maximum upon interposing aggregates (fibers and particles) between a pair of parallel surfaces. Further, the “minimum diameter” means a length that becomes minimum upon interposing the aggregates (fibers and particles) between the pair of parallel surfaces. In the plate-shaped ceramic particles, “thickness” corresponds to the “minimum diameter”. The anisotropic ceramics may have an aspect ratio (maximum diameter/minimum diameter) of 5 or more and 100 or less within a range of the maximum diameter being 5 μm or more and 200 μm or less and the minimum diameter being 0.01 μm or more and 20 μm or less. When the aspect ratio is 5 or more, the sintering of the ceramic particles can sufficiently be suppressed, and when the ratio is 100 or less, strength deterioration in the anisotropic ceramics is suppressed, and the strength of the first layer is sufficiently maintained.

The ceramic particles contained in the first layer may be used as a binder that binds the anisotropic ceramics (plate-shaped ceramic particles and ceramic fibers) being aggregates constituting a framework of the first layer. Metal oxide(s) may be used as a material of the ceramic particles. As such metal oxide(s), alumina (Al₂O₃), spinel (MgAl₂O₄), titania (TiO₂), zirconia (ZrO₂), magnesia (MgO), mullite (Al₆O₁₃Si₂), and cordierite (MgO.Al₂O₃.SiO₂) may be exemplified. The aforementioned metal oxides are chemically stable even within a high-temperature exhaust gas, for example. The ceramic particles may be granular, and a size thereof (pre-firing average diameter) may be 0.05 μm or more and 1.0 μm or less. When the size of the ceramic particles is too small, the sintering in the manufacturing process (firing step) of the porous protective layer becomes excessive, and a sintered body becomes prone to shrinking. Further, when the size of the ceramic particles is too large, a performance to bind the aggregates to each other cannot be exhibited sufficiently. The size of the ceramic particles may be constant or vary along a thickness direction of the porous protective layer.

In addition to the metal oxides described as the material of the ceramic particles as aforementioned, minerals, clay, and glass such as talc (Mg₃Si₄O₁₀(OH)₂), mica, and kaolin may be used as a material of the plate-shaped ceramic particles. The plate-shaped ceramic particles may have a rectangular plate shape or a needle shape. A maximum diameter of the plate-shaped ceramic particles may be 5 μm or more and 50 μm or less. When the maximum diameter of the plate-shaped ceramic particles is 5 μm or more, the excessive sintering of the ceramic particles can be suppressed. Further, when the maximum diameter of the plate-shaped ceramic particles is 50 μm or less, the heat transfer paths within the first layer can be blocked by the plate-shaped ceramic particles, and the element body can suitably be thermally insulated from an external environment.

In addition to the metal oxides described as the material of the ceramic particles as aforementioned, glass may be used as a material of the ceramic fibers. A maximum diameter of the ceramic fibers may be 50 μm or more and 200 μm or less. Further, a minimum diameter of the ceramic fibers may be 1 to 20 μm. In a thickness direction of a porous ceramic layer, types of the ceramic fibers to be used (materials and sizes thereof) may be varied.

As aforementioned, the porous protective layer (first layer) may be constituted of the ceramic particles and the anisotropic ceramics (plate-shaped ceramic particles and ceramic fibers). The porous protective layer may be manufactured using a raw material that mixed the aforementioned materials and also a binder, a pore-forming agent, and solvent. An inorganic binder may be used as the binder. As examples of the inorganic binder, alumina sol, silica sol, titania sol, and zirconia sol may be exemplified. These inorganic binders can improve the strength of the fired porous protective layer. As the pore-forming agent, polymeric pore-forming agent and carbon-based powder may be used. Specifically, acrylic resin, melamine resin, polyethylene particles, polystyrene particles, cellulose fibers, starch, carbon black powder, and graphite powder may be exemplified. The pore-forming agent may have various shapes conforming to a purpose thereof, and may for example be spherical, plate-shaped, or fibrous. By selecting a dosage, size, and shape of the pore-forming agent, the porosity and a pore size of the porous protective layer can be adjusted. The solvent may simply be capable of adjusting viscosity of a raw material without affecting the additional material, and for example, water, ethanol, and isopropyl alcohol (IPA) may be used.

In the sensor element disclosed herein, the aforementioned raw material is applied to the surface of the element body in which the second layer is arranged, for example, and the porous protective layer is arranged on the surface of the element body after having undergone drying and firing. As an application method of the raw material, dip coating, spin coating, spray coating, slit-die coating, thermal spraying, aerosol deposition (AD) method, printing, and mold casting may be used.

Among the aforementioned application methods, the dip coating is advantageous in that it is capable of applying the raw material uniformly over an entire surface of the element body in one coating session. In the dip coating, slurry viscosity of the raw material, a drawing speed of an object to be coated (element body), a drying condition of the raw material, and a firing condition are adjusted in accordance with a type and applied thickness of the raw material. As am example, the slurry viscosity is adjusted to 50 to 7000 mPa·s. The drawing speed is adjusted to 0.1 to 10 mm/s. The drying condition is adjusted to drying temperature: room temperature to 300° C. and drying time: 1 minute or more. The firing condition is adjusted to firing temperature: 800 to 1200° C., firing time: 1 to 10 hours, and firing atmosphere: atmospheric atmosphere. In a case of configuring the porous protective layer by a multiplayer structure, firing may be performed after having constructed the multilayer structure by repeating dipping and drying, or the multilayer structure may be constructed by performing dipping, drying, and firing for each layer.

### First Embodiment

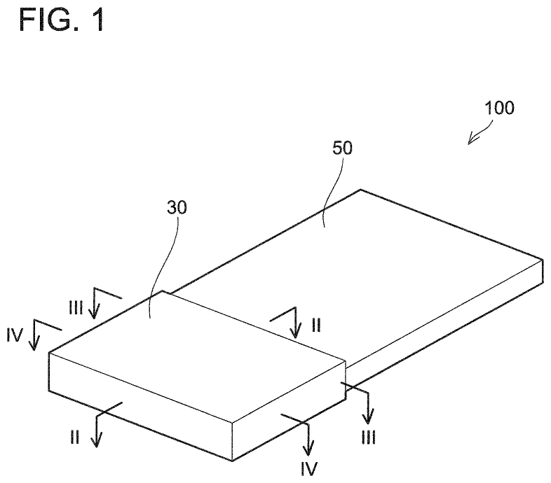

A sensor element 100 will be described with reference to FIGS. 1 to 5. In the following description, a relationship of an element body 50 in which a sensor structure is constructed and a porous protective layer 30 covering the element body 50 will be described, and explanation on the sensor structure will be omitted.

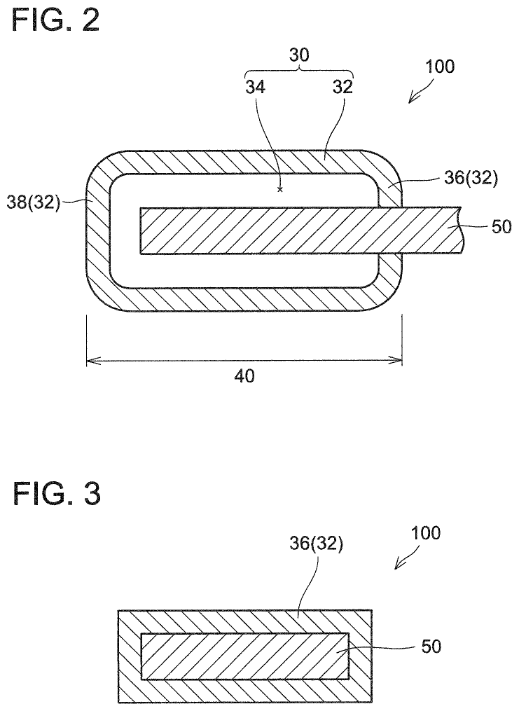

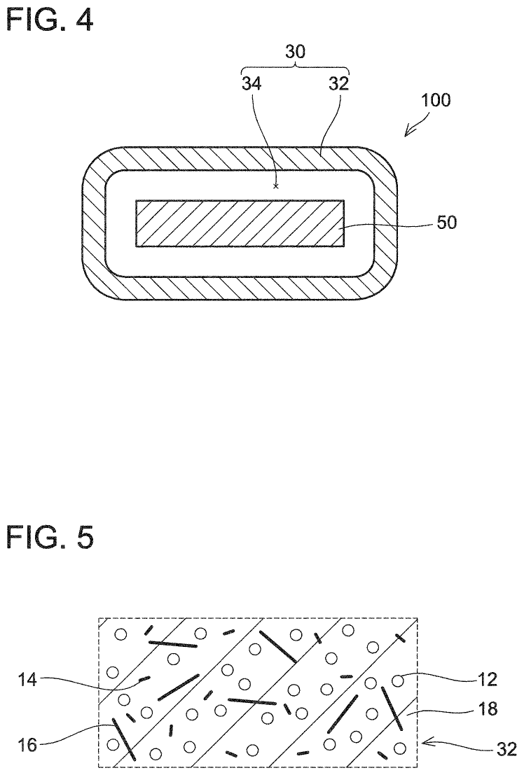

As shown in FIG. 1, the sensor element 100 includes the stick-shaped element body 50 and the porous protective layer 30 covering the element body 50 from a longitudinally intermediate portion to one end of the element body 50. As shown in FIG. 2, the porous protective layer 30 includes an outer layer (first layer) 32 and an inner layer (second layer) 34. In a range 40 in which the porous protective layer 30 covers the element body 50, the outer layer 32 is in contact with the element body 50 at an end (first end 36) of the outer layer 32 on a longitudinally intermediate portion side of the element body 50. On the other hand, the outer layer 32 is not in contact with the element body 50 at an end (second end 38) on a longitudinal end side of the element body 50, and surrounds front and rear surfaces, side surfaces, and an end surface of the element body 50. Further, as shown in FIG. 3, at the first end 36, the outer layer 32 contacts all circumferential surfaces of the element body 50. Due to this, in the range 40, the element body 50 is not exposed to an external space (is covered completely by the porous protective layer 30). As shown in FIG. 4, the outer layer 32 is not in contact with the element body 50 between the first end 36 and the second end 38.

The outer layer 32 includes a sintered body (matrix) of ceramic particles and anisotropic ceramics (plate-shaped ceramic particles and ceramic fibers). A porosity of the outer layer 32 is about 20 vol %. A ratio of the anisotropic ceramics in the outer layer 32 “{(anisotropic ceramics)/(anisotropic ceramics)+(ceramic particles)}×100” is about 50 vol %. Further, a surface area S2 of a portion (first end 36) where the outer layer 32 is in contact with the element body 50 with respect to a surface area S1 of the element body 50 is adjusted to satisfy the following equation (1). Specifically, an area ratio (S2/S1) can be adjusted by changing a size of the first end 36.

10≤(S2/S1)×100≤80 (1)

The inner layer 34 is an aerial layer. That is, the inner layer 34 is a space with a 100% porosity arranged between the outer layer 32 and the element body 50. The inner layer 34 can be constructed upon forming the porous protective layer 30 by forming a resin layer on the surface of the element body 50, then forming a ceramics layer (outer layer 32) on the resin layer, and thereafter firing to eliminate the resin layer. Since the porous protective layer 30 is given the space (inner layer 34) that serves as a heat insulating layer between the outer layer 32 and the element body 50, heat transfer from the outer layer 32 to the element body 50 can be suppressed.

FIG. 5 schematically shows a structure of the outer layer 32. As shown in FIG. 5, the outer layer 32 is constituted of a matrix 18, ceramic fibers 16, and plate-shaped ceramic particles 14. The matrix 18 is a sintered body of ceramic particles, and binds the ceramic fibers 16 and the plate-shaped ceramic particles 14 that are aggregates. The ceramic fibers 16 and the plate-shaped ceramic particles 14 are present within the outer layer 32 by being substantially uniformly dispersed therein. Pores 12 are contained in the matrix 18. The pores 12 are traces of a pore-forming agent that was added to a raw material upon constructing the outer layer 32.

That is, the pores 12 are generated in a manufacturing process (firing step) of the porous protective layer 30 as a result of the pore-forming agent having been eliminated. The porosity of the outer layer 32 can be adjusted by adjusting an amount of the pores 12.

### Second Embodiment

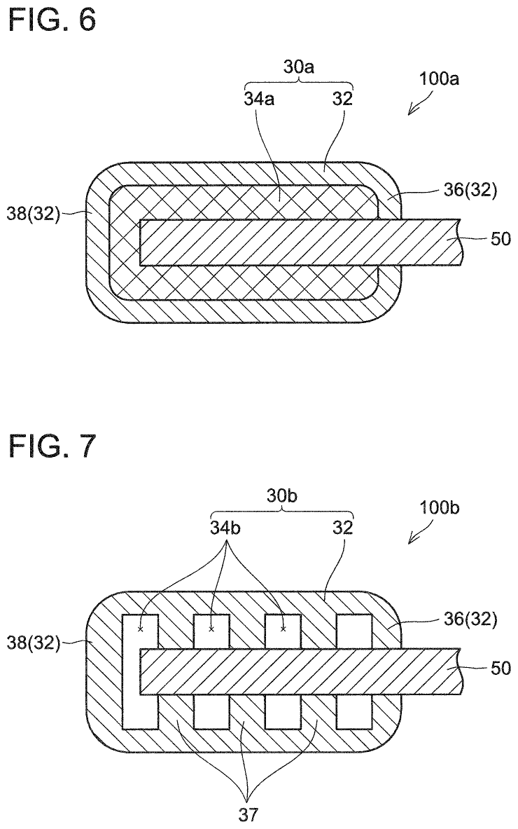

A sensor element 100a will be described with reference to FIG. 6. The sensor element 100a is a variant of the sensor element 100, and differs in a structure of a porous protective layer 30a from the porous protective layer 30 of the sensor element 100. Configurations of the sensor element 100a that are substantially same as those of the sensor element 100 are given same reference numbers as those of the sensor element 100, and description thereof may be omitted.

The porous protective layer 30a includes the outer layer 32 and an inner layer 34a. The inner layer 34a is a ceramic layer constituted of ceramic fibers and ceramic particles, and is adjusted to a porosity of 95% or more. The inner layer 34a is constructed upon forming the porous protective layer 30a by forming a resin layer containing ceramic fibers and ceramic particles on the surface of the element body 50, then forming a ceramics layer (outer layer 32) on the resin layer, and thereafter firing to eliminate the resin layer. The porous protective layer 30a achieves higher strength as compared to the porous protective layer 30 (see FIG. 2).

### Third Embodiment

A sensor element 100b will be described with reference to FIG. 7. The sensor element 100b is a variant of the sensor element 100, and differs in a structure of a porous protective layer 30b from the porous protective layer 30 of the sensor element 100. Configurations of the sensor element 100b that are substantially same as those of the sensor element 100 are given same reference numbers as those of the sensor element 100, and description thereof may be omitted.

The porous protective layer 30b includes a plurality of pillars 37 between the first end 36 and the second end 38. Each of the pillars 37 is in contact with the outer layer 32 and the element body 50. In other words, in the porous protective layer 30b, the outer layer 32 is in contact with the element body 50 at multiple points. An inner layer 34b is divided into multiple regions by the pillars 37. The porous protective layer 30b achieves higher strength as compared to the porous protective layer 30 (see FIG. 2).

### Fourth Embodiment

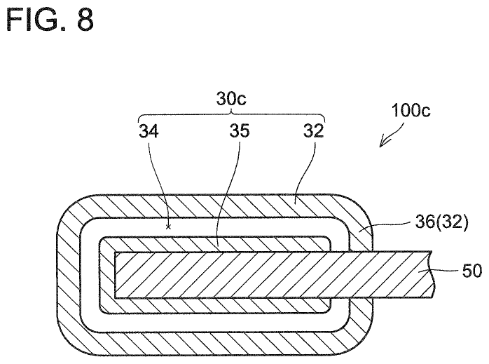

A sensor element 100c will be described with reference to FIG. 8. The sensor element 100c is a variant of the sensor element 100, and differs from the porous protective layer 30 of the sensor element 100 in that a porous protective layer 30c has a three-layer structure. Configurations of the sensor element 100c that are substantially same as those of the sensor element 100 are given same reference numbers as those of the sensor element 100, and description thereof may be omitted.

The porous protective layer 30c includes the outer layer 32, the inner layer 34, and a cover layer 35. The cover layer (third layer) 35 contacts the surface of the element body 50 but does not contact the outer layer 32. The cover layer 35 is constituted of a substantially same material as the outer layer 32, thus is constituted of a matrix 18, ceramic fibers 16, and plate-shaped ceramic particles 14 (see FIG. 5 as well). By having the cover layer 35, a volume of the inner layer (space) 34 decreases accordingly. As a result, strength of the porous protective layer 30c is improved.

### EXAMPLES

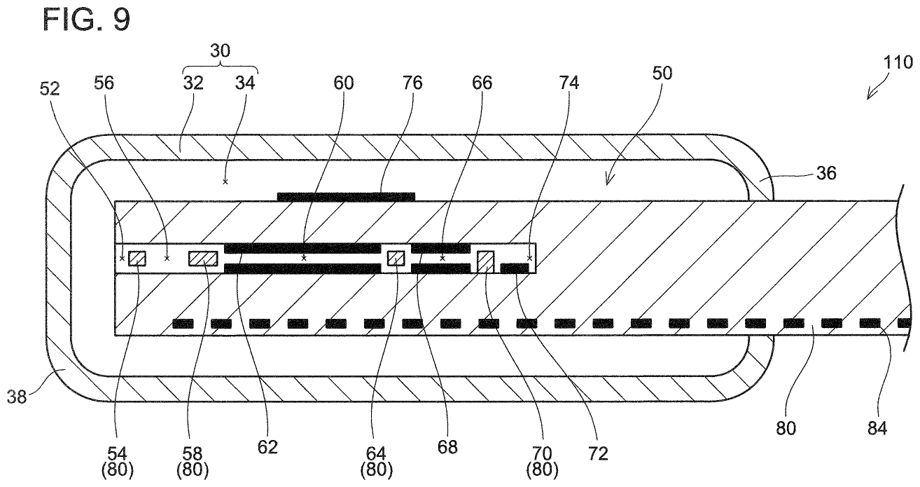

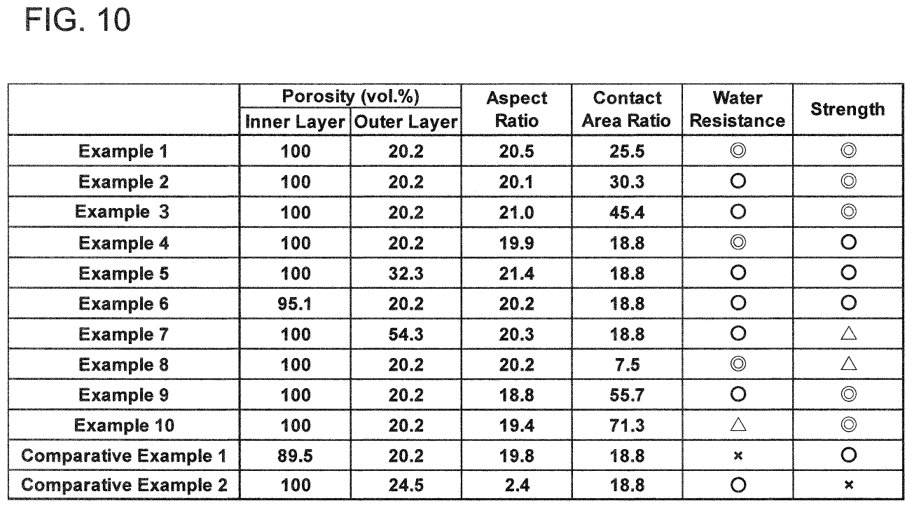

A sensor element 110 shown in FIG. 9 was fabricated. The sensor element 110 includes an element body 50 in which a sensor structure is constructed, and a porous protective layer 30 covering the element body 50 from a longitudinally intermediate portion to one end of the element body 50. The porous protective layer 30 includes an outer layer 32 and an inner layer 34. Further, for the sensor element 110, samples (Examples 1 to 10 and Comparative Examples 1 and 2) with different structures of the porous protective layer 30 were fabricated, and characteristics (water resistance and strength) of the sensor element 110 were evaluated. Specifically, the characteristics were evaluated by varying a porosity of the outer layer 32, a porosity of the inner layer 34, an aspect ratio of anisotropic ceramics (plate-shaped ceramic particles and ceramic fibers) contained in the outer layer 32, and a contact area ratio R1 ((S2/S1)×100) of the outer layer 32 with respect to the element body 50. The characteristics and evaluation results of the respective samples are shown in FIG. 10. The “porosity”, “contact area ratio R1”, and “aspect ratio” shown in FIG. 10 indicate evaluations of the fabricated sensor element 110.

The porosity was obtained by observing a cross section of the outer layer 32 using a SEM (Scanning electron Microscope), binarizing an observed image into a space and a non-space portion, and calculating a ratio of the space over an entirety.

The contact area ratio R1 was obtained by calculating a total surface area Si of surfaces of the element body 50 (front and rear surfaces, side surfaces, and longitudinal end surfaces) in a range 40 (see FIG. 2) in which the porous protective layer 30 covers the element body 50, measuring a contact area S2 between the element body 50 and the outer layer 32 (first end 36), and calculating “R1=((S2/S1)×100)”. The contact area S2 was calculated by capturing X-ray CT images at 50 μm intervals in a circumferential direction of the sensor element 110, measuring the contact area between the outer layer 32 and the element body 50 in each captured portion, and adding measured contact areas.

The aspect ratio was calculated by observing the cross section of the outer layer 32 using the SEM (Scanning electron Microscope), selecting arbitrary 100 particles (anisotropic ceramics), measuring maximum and minimum diameters of the 100 particles, and calculating averages thereof.

The sensor element 110 corresponds to the sensor elements 100, 100b (see FIGS. 2 to 4 and 6), and is used for example as a gas sensor attached to an exhaust pipe of a vehicle having an engine for measuring a concentration of detection-target gas (NOx, oxygen) contained in exhaust gas. Hereinbelow, a structure of the element body 50 will briefly be described.

The element body 50 is composed of a base 80 that is primarily constituted of zirconia, electrodes 62, 68, 72, 76 arranged inside and outside the base 80, and a heater 84 embedded in the base 80. The base 80 has oxygen ion conductivity. A space having an opening 52 is defined inside the base 80, which is partitioned into a plurality of spaces 56, 60, 66 and 74 by diffusion controlling elements 54, 58, 64 and 70. The diffusion controlling elements 54, 58, 64 and 70 are a part of the base 80, and are columnar elements extending from both side surfaces. Due to this, the diffusion controlling elements 54, 58, 64 and 70 do not completely separate the respective spaces 56, 60, 66, and 74 from one another. The diffusion controlling elements 54, 58, 64 and 70 limit a moving speed of detection-target gas introduced from the opening 52.

The space inside the base 80 is partitioned into a buffer space 56, a first space 60, a second space 66, and a third space 74 in this order from an opening 52 side. The cylindrical inner pump electrode 62 is arranged in the first space 60. The cylindrical auxiliary pump electrode 68 is arranged in the second space 66. The measurement electrode 72 is arranged in the third space 74. The inner pump electrode 62 and the auxiliary pump electrode 68 are constituted of a material with low NOx reducing ability. On the other hand, the measurement electrode 72 is constituted of a material with high NOx reducing ability. Further, the outer pump electrode 76 is arranged on a surface of the base 80. The outer pump electrode 76 faces a part of the inner pump electrode 62 and a part of the auxiliary pump electrode 68 via the base 80.

An oxygen concentration of the detection-target gas in the first space 60 is adjusted by applying a voltage between the outer pump electrode 76 and the inner pump electrode 62. Similarly, an oxygen concentration of the detection-target gas in the second space 66 is adjusted by applying a voltage between the outer pump electrode 76 and the auxiliary pump electrode 68. The detection-target gas of which oxygen concentration has been adjusted with high precision is introduced into the third space 74. In the third space 74, NOx in the detection-target gas is decomposed by the measurement electrode (NOx reducing catalyst) 72, and oxygen is thereby generated. A NOx concentration in the detection-target gas is detected by applying a voltage to the outer pump electrode 76 and the measurement electrode 72 such that an oxygen partial pressure in the third space 74 becomes constant, and measuring a current value in this state. The buffer space 56 is a space for buffering concentration fluctuation in the detection-target gas introduced from the opening 52. In detecting the NOx concentration of the detection-target gas, the base 80 is heated to 500° C. or more using the heater 84. The heater 84 is embedded in the base 80 facing positions where the electrodes 62, 68, 72, 76 are arranged so as to increase the oxygen ion conductivity of the base 80. By increasing the temperature of the base 80 by the heater 84, the base (oxygen ion conductive solid electrolyte) 80 is activated.

A fabrication method of the porous protective layer 30 will be described. Firstly, an inner layer slurry and an outer layer slurry were prepared, one end of the element body 50 was immersed in the inner layer slurry to form a 400 μm inner layer. After this, the element body 50 was introduced in a dryer, and the inner layer was dried for one hour at 200° C. (atmospheric atmosphere). Then, the portion of the element body 50 where the inner layer was formed and a part of the element body 50 were immersed in the outer layer slurry to form a 400 μm outer layer. After this, the element body 50 was placed in the dryer and the outer layer was dried for one hour at 200° C. (atmospheric atmosphere). Then, the element body 50 was placed in an electric furnace, degreased (eliminated the inner layer) for six hours at 450° C., and fired for three hours at 1100° C. (atmospheric atmosphere).

The inner layer slurry will be described. The inner layer slurry was prepared by mixing cellulose fibers (with average maximum diameter of 20 μm), acrylic resin (PMMA), water, and alumina sol. The cellulose fibers were adjusted to 10% by volume ratio with respect to the acrylic resin. The water is a solvent, and was adjusted to achieve inner layer slurry viscosity of 200 mPa·s. Further, the alumina sol corresponds to a binder (inorganic binder). In Example 6 and Comparative Example 2, a part (or all of) the cellulose fibers was replaced with alumina fibers (with average maximum diameter of 140 μm) and titania particles (with average particle diameter of 0.25 μm). Specifically, Example 5 added the alumina fibers to 2.5% by volume ratio with respect to the acrylic resin and added the titania particles to 2.5% by volume ratio with respect to the acrylic resin. Further, Comparative Example 2 added the alumina fibers to 5.0% by volume ratio with respect to the acrylic resin and added the titania particles to 5.0% by volume ratio with respect to the acrylic resin. That is, Comparative Example 2 did not use the cellulose fibers.

The outer layer slurry will be described. The outer layer slurry was prepared by mixing alumina fibers (with average maximum diameter of 140 μm), plate-shaped alumina particles (with average maximum diameter of 6 μm), titania particles (with average particle diameter of 0.25 μm), alumina sol (with alumina content of 1.1%), acrylic resin (with average particle diameter of 8 μm), and water. The alumina fibers and plate-shaped alumina particles correspond to aggregates, and in Examples 1 to 10 and Comparative Example 1, those with the aspect ratio of 18 to 22 were used, and those with the aspect ratio of 2.4 were used in Comparative Example 2. The titania particles correspond to a bonding material, and the alumina sol corresponds to a binder (inorganic binder). The alumina sol was added by 10 wt % with respect to a total weight of the aggregates and the bonding material. The acrylic resin corresponds to a pore-forming agent, and the porosity of the outer layer 32 was adjusted by adjusting the amount of the acrylic resin. The water is a solvent, and was adjusted to achieve first slurry viscosity of 200 mPa·s.

Water resistance test and strength test were conducted on the prepared samples (Examples 1 to 10 and Comparative Examples 1 and 2). Results thereof are shown in FIG. 10. In the water resistance test, the sensor element 110 was driven in open air, 15 to 40 μL of water droplets were dripped onto the porous protective layer 30, and morphological changes in the porous protective layer 30 and the element body 50 were observed. Specifically, the heater 84 was electrically conducted so that inside of the first space 60 enters a heated state, and the value of current flowing between the outer pump electrode 76 and the inner pump electrode 62 was measured in a state of applying voltage between the outer pump electrode 76 and the inner pump electrode 62 such that the oxygen concentration in the first space 60 is maintained constant. After the value of current because constant, electric conduction of the heater 84 was stopped after having dripped the water droplets on the surface of the porous protective layer 30, and the morphological changes in the porous protective layer 30 and the element body 50 were observed.

For the morphological change in the porous protective layer 30, presence/absence of crack and exfoliation were visually observed. Further, for the morphological change in the element body 50, presence/absence of crack was observed using X-ray CT. In FIG. 10, a sample in which deterioration (crack, exfoliation) did not occur with 404, of water droplets is given “⊚”, a sample in which the deterioration did not occur with 20 μL of water droplets but occurred with 404, of water droplets is given “◯”, a sample in which the deterioration did not occur with 15 μL of water droplets but occurred with 20 μL of water droplets is given “Δ”, and a sample in which the deterioration occurred with 15 μL of water droplets is given “x”. A higher degree of excellence in the water resistance of the porous protective layer 30 indicates that thermal insulation of the porous protective layer 30 is superior.

In the strength test, the samples were freely dropped from a height of 5 to 15 cm onto concrete, and presence/absence of damage in the porous protective layer 30 was visually observed. The samples were freely dropped in a posture in which a main surface of the sensor element 110 (surface with maximum surface area) is parallel to the concrete. In FIG. 10, a sample in which damage did not occur at the height of 15 cm is given “0”, a sample in which the damage did not occur at the height of 10 cm but occurred at the height of 15 cm is given “0”, a sample in which the damage did not occur at the height of 5 cm but occurred at the height of 10 cm is given “Δ”, and a sample in which the damage occurred at the height of 5 cm is given “x”.

As shown in FIG. 10, all of the samples with the porosity of the inner layer 34 being 95 vol % or more (Examples 1 to 10 and Comparative Example 2) have been confirmed as capable of obtaining superior water resistance (see Comparative Example 1 as well). Especially, the samples with the porosity of the inner layer 34 being 100 vol % (space), the porosity of the outer layer 32 being 21 vol % or less (20.2%), and the contact area between the outer layer 32 and the element body 50 being 26% or less (Examples 1, 4, and 8) have been confirmed as obtaining a significantly superior result. The results of the water resistance test indicate that the water resistance is improved by arranging a high-heat insulating layer (inner layer 34) between the outer layer 32 and the element body 50 and also by reducing the contact area ratio of the outer layer 32 with respect to the element body 50.

Further, all of the samples in which the outer layer 32 includes the anisotropic ceramics (alumina fibers and plate-shaped alumina particles) with the aspect ratio of 5 or more (Examples 1 to 10 and Comparative Example 1) have been confirmed as that the porous protective layer 30 has high strength (see Comparative Example 2 as well). Especially, the samples with the porosity of the outer layer 32 being 50% or less and the contact area ratio of the outer layer 32 with respect to the element body 50 being 10% or more (Examples 1 to 6, 9, and 10 and Comparative Example 1) have been confirmed as obtaining high strength. Further, the samples with the contact area ratio of the outer layer 32 with respect to the element body 50 being 25% or more (Examples 1 to 3, 9, and 10) have been confirmed as obtaining a significantly superior result. The results of the strength test indicate that the strength of the outer layer 32 is improved by adding the anisotropic ceramics for strengthening the outer layer 32 to the outer layer 32.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

1. A sensor element comprising:
an element body; and
a porous protective layer covering a surface of the element body,
wherein
the porous protective layer comprises a first layer exposed on a surface of the sensor element and a second layer disposed between the element body and the first layer,
the first layer contains ceramic particles and anisotropic ceramics having an aspect ratio of 5 or more and 100 or less, and a part of the first layer is in contact with the element body, and
a porosity of the second layer is 95 vol % or more.

2. The sensor element according to claim 1, wherein a porosity of the first layer is 5 vol % or more and 50 vol % or less.

3. The sensor element according to claim 2, wherein
an equation (1) as follows is satisfied within a range in which the porous protective layer covers the element body:
10≤(S2/S1)×100≤80 (1)
where a surface area of the element body is S1 and a contact area between the element body and the first layer is S2.

4. The sensor element according to claim 3, wherein
a volume fraction of the anisotropic ceramics in the first layer is 20 vol % or more and 80 vol % or less with respect to a total volume of the ceramic particles and the anisotropic ceramics.

5. The sensor element according to claim 4, wherein
a maximum diameter of the anisotropic ceramics is 5 μm or more and 200 μm or less.

6. The sensor element according to claim 5, wherein
a minimum diameter of the anisotropic ceramics is 0.01 μm or more and 20 μm or less.

7. The sensor element according to claim 1, wherein
an equation (1) as follows is satisfied within a range in which the porous protective layer covers the element body:
10≤(S2/S1)×100≤80 (1)
where a surface area of the element body is Si and a contact area between the element body and the first layer is S2.

8. The sensor element according to claim 1, wherein
a volume fraction of the anisotropic ceramics in the first layer is 20 vol % or more and 80 vol % or less with respect to a total volume of the ceramic particles and the anisotropic ceramics.

9. The sensor element according to claim 1, wherein
a maximum diameter of the anisotropic ceramics is 5 μm or more and 200 μm or less.

10. The sensor element according to claim 1, wherein
a minimum diameter of the anisotropic ceramics is 0.01 μm or more and 20 μm or less.
